(19) United States
(12) Patent Application Publication
(10) Pub. No.: US 2005/0206194 A1
(43) Pub. Date: Sep. 22, 2005

(54) Door structure for automobile

(75) Inventors: Yoshihiro Kohara, Hiroshima-shi (JP); Shinichiro Emori, Hiroshima-shi (JP)

Correspondence Address: FRISHAUF, HOLTZ, GOODMAN & CHICK, PC, 220 5TH AVE FL 16, NEW YORK, NY, 10001-7708, US

(73) Assignee: Nishikawa Rubber Co., Ltd., Hiroshima-shi (JP)

(21) Appl. No.: 11/035,267

(22) Filed: Jan. 13, 2005

(30) Foreign Application Priority Data
Mar. 19, 2004 (JP) JP2004-120919

(51) Int. Cl. B60J 5/00

(52) U.S. Cl. 296/146.7

(57) ABSTRACT

There is provided a door structure for an automobile. The door structure comprises a door inner panel 2, a projecting object 3 such as an audio speaker provided to an interior side of the door inner panel 12, an isolation sheet 5 installed to roughly cover an entire surface of the door inner panel 2 and the projecting object 12, and a door trim 8 installed to cover the isolation sheet 5. The isolation sheet 5 is provided with a hole 6 for the projecting object 12, which comprises a shape roughly similar to an outer shape of the projecting object 3. The isolation sheet 5 is provided with a plural number of slits 7 radially formed in a peripheral of the hole 6 with a proper interval between each slit 7.

### BACKGROUND OF THE INVENTION

This invention relates to a door structure for an automobile comprising a speaker and an isolation sheet installed between a door inner panel and a door trim of an automobile door.

As illustrated in FIG. 3, there has conventionally been a door structure which comprises an audio speaker 3 and a waterproofing hole seal 4 in an interior side of a door inner panel 2 of an automobile door 1. Further there has been a door structure which comprises an isolation sheet 10 instead of the hole seal 4, which covers roughly an entire area of a door inner panel. This isolation sheet 10 comprises a speaker hole 11 which is hollowed and formed in a shape similar to an outer shape of the speaker 3 in order for the speaker 3 to project through the hole 11. The isolation sheet 10 is installed to the door inner panel 2 by securing an upper end portion thereof to the door inner panel 2, or it is installed by securing the upper end portion thereof to a door trim 8 which is installed afterward to cover the isolation sheet 10 and secured with a plural number of pins 9 stabbed on a periphery thereof.

However, there was a problem in the prior art that an installation operation of the isolation sheet 10 was hard to complete since a revision in positioning of the isolation sheet 10 was required by expanding and contracting a periphery of the hole 11 in the isolation sheet 10 and by moving the isolation sheet 10 from a proper position when the outer shape of the speaker 3 did not properly engage with the hole 11 at a time the isolation sheet 10 is installed by passing the speaker 3 through the hole 11 to project.

### SUMMARY OF THE INVENTION

The invention is invented in the light of the aforementioned problem, and it is therefore an object of this invention to provide a door structure for an automobile which does not require a revision of positioning between a isolation sheet 10 and an audio speaker 3 during an installation operation of the isolation sheet 10.

In order to achieve the aforementioned object, there is provided, as illustrated in FIG. 1, a door structure for an automobile. The door structure comprises a door inner panel 2, a projecting object 3 such as a speaker provided to an interior side of the door inner panel 2, an isolation sheet 5 installed to cover roughly an entire surface of the door inner panel 2 and the projecting object 3, and a door trim 8 installed over the isolation sheet 5. The isolation sheet 5 is provided with a hole 6 for the projecting object 3, which comprises a shape roughly similar to an outer shape of the projecting object 3. The isolation sheet 5 is provided with a plural number of slits 7 radially formed in a peripheral of the hole 6 with a proper interval between each slit 7.

According to the door structure of the invention, the isolation sheet 5, which is installed to the interior side of the door inner panel 2, is provided with the hole 6 for the projecting object 3, and the hole 6 is provided with the slits 7 radially formed in its peripheral with a proper interval between each slit 7, so that an installation operation of the isolation sheet 5 becomes easier. It is because the slits 7 absorb variations of measurement and shape of the hole 6 relative to the projecting object 3 when the isolation sheet 5 is installed, and thus, unlike the prior art, there is unneeded to carry out a revision of positioning between the projecting object 3 and the hole 6.

### BRIEF DESCRIPTION OF THE DRAWINGS

FIG. 1 is a front view showing a substantial part of a door structure for an automobile according to the invention;

FIG. 2 is a perspective view showing a door structure for an automobile according to the invention;

FIG. 3 is a perspective view showing a door structure for an automobile according to a prior art;

and, FIG. 4 is a perspective view showing a construction in which the isolation sheet 5 illustrated in FIG. 2 is installed.

### DETAILED DESCRIPTION OF THE INVENTION

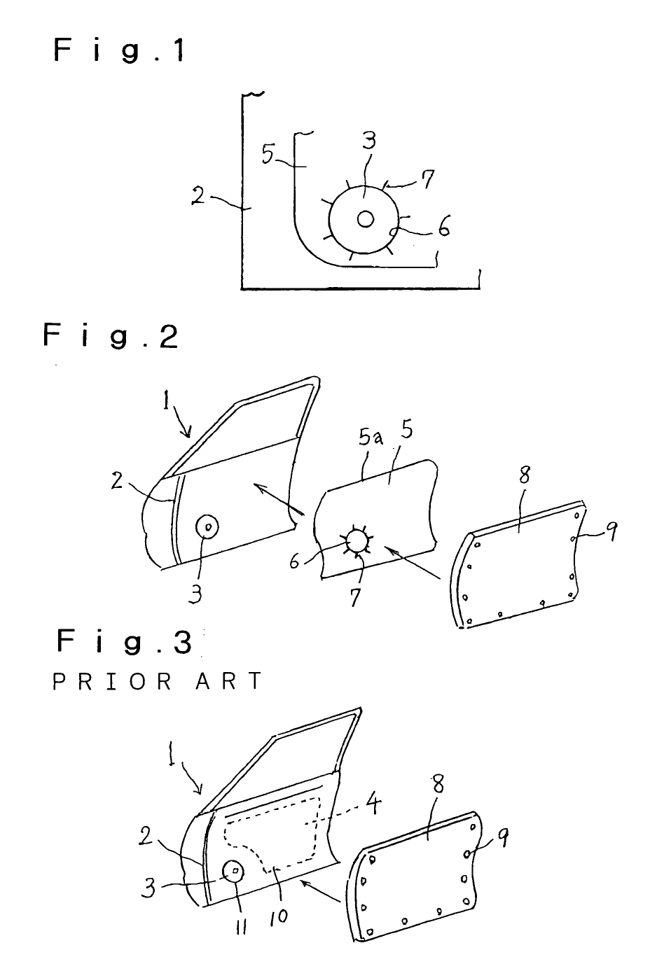

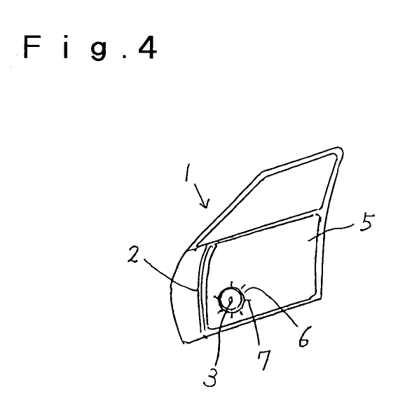

There will be described a preferred embodiment of the invention below referring to the drawings. In FIGS. 1 and 2, the numeral “1” indicates an automobile door. A projecting object 3, e.g., a speaker, is installed to an interior side of an inner panel 2 of this door. There is provided an isolation sheet 5 made of a sponge material with low density which roughly covers an entire area of the interior side of the door inner panel 2. The isolation sheet 5 is provided with a hole 6 which is formed in a round shape roughly similar to the shape of the projecting object 3. The isolation sheet 5 is also provided with a plural number of slits 7, each of which has a short length of about 1 to 3 mm, radially formed in a periphery of the hole 6 with a proper interval between each slit 7. Further, the isolation sheet 5 is secured to either the door inner panel 2 or the door trim 8 at its upper end edge 5a and is installed hanging down like a curtain.

Further, there is provided a door trim 8, which is made of resin or other materials, to cover the isolation sheet 5. The isolation sheet 5 and the door trim 8 are secured to the door inner panel 2 by penetrating a plural number of pins 9 in a periphery thereof.

According to this embodiment, when the isolation sheet 5 is installed by passing the speaker 3 through the hole 6 thereof, variations of measurement and shape of the hole 6 are absorbed by the short slits 7 formed in the periphery of the hole 6, so that an installation operation of the isolation sheet 5 becomes easier and the isolation sheet 5 can be installed in a proper position without a revision of positioning.

It should be noted that although the above mentioned preferred embodiment is described in that the projecting object 3 merely includes a speaker, the projecting object 3 may include other objects such as a inner handle or a coupler.

1. A door structure for an automobile which comprises:
a door inner panel 2;
a projecting object 3 such as an audio speaker provided to an interior side of said door inner panel 2;
an isolation sheet 5 installed to roughly cover an entire surface of said door inner panel 2 and said projecting object 3;
a door trim 8 installed to cover said isolation sheet 5, wherein;
said isolation sheet 5 is provided with a hole 6 for said projecting object 3 having a shape roughly similar to an outer shape of said projecting object 3;
and, said isolation sheet 5 is provided with a plural number of slits 7 radially formed in a peripheral of said hole 6 with a proper interval between each slit 7.
